(19) United States
(12) Patent Application Publication
(10) Pub. No.: US 2013/0038611 A1
(43) Pub. Date: Feb. 14, 2013

(54) IMAGE CONVERSION DEVICE

(71) Applicants: Toshiya Noritake, Osaka (JP); Kazuhiko Kono, Osaka (JP); Tetsuya Itani, Nara (JP)

(72) Inventors: Toshiya Noritake, Osaka (JP); Kazuhiko Kono, Osaka (JP); Tetsuya Itani, Nara (JP)

(73) Assignee: Panasonic Corporation, Osaka (JP)

(21) Appl. No.: 13/643,802

(22) PCT Filed: Apr. 27, 2011
(86) PCT No.: PCT/JP2011/002472

§ 371 Date: Oct. 26, 2012

(30) Foreign Application Priority Data
Apr. 28, 2010 (JP) 2010-103327
Oct. 12, 2010 (JP) 2010-229433

(51) Int. Cl. G06T 15/00

(52) U.S. Cl. 345/419

(57) ABSTRACT

The image conversion apparatus converts non-stereoscopic image data into stereoscopic image data configured by left-eye image data and right-eye image data. The image conversion apparatus includes an input unit that inputs a non-stereoscopic image, and a conversion unit that generates and outputs the left-eye image data and the right-eye image data based on the non-stereoscopic image data input through the input unit. When a stereoscopic image configured by the left-eye image and the right-eye image is displayed on a display apparatus capable of displaying a stereoscopic image, the conversion unit generates the left-eye image data and the right-eye image data to cause a user to visually recognize the stereoscopic image so that a predetermined portion in a horizontal direction in the displayed stereoscopic image is present at a position farthest from the user in a direction vertical to a display surface of the display apparatus, and a portion other than the predetermined portion is present at a position closer to the user toward left and right ends of the stereoscopic image.

### TECHNICAL FIELD

The present invention relates to an image conversion apparatus that converts a two-dimensional image (2D image) into a three-dimensional stereoscopic image (3D image).

### BACKGROUND ART

Various systems are planned and realized as devices for reproducing 3D images. A reproducing apparatus for reproducing a 3D image reads a left-eye image signal and a right-eye image signal from, for example, a disk, to alternately output the read left-eye image signal and the read right-eye image signal to a display. When a display is used in combination with glasses with a liquid crystal shutter as described in Patent Document 1, the display alternately displays a left-eye image indicated by a left-eye image signal input from a reproducing apparatus and a right-eye image indicated by a right-eye image signal input from the reproducing apparatus on a screen in a predetermined cycle. The display controls the glasses with liquid crystal shutter such that a left-eye shutter of the glasses with liquid-crystal shutter opens when the left-eye image indicated by the left-eye image signal is displayed and a right-eye shutter of the glasses with liquid crystal shutter opens when the right-eye image indicated by the right-eye image signal is displayed. With this configuration, only the left-eye image reaches the left eye of a user who wears the glasses with liquid crystal shutter, and only the right-eye image reaches the right eye. Thus, the user can visually recognize a three-dimensional stereoscopic image.

Meanwhile, contents including 3D images are not sufficiently provided at the present. For this reason, there is proposed an image conversion apparatus that converts existing 2D images into 3D images. With this, a user can view the existing 2D image as the 3D image.

### PRIOR ART DOCUMENT

### Patent Document

Patent Document 1: JP-A-2002-82307

### DISCLOSURE OF INVENTION

### Problem to be Solved by the Invention

However, a 3D image provided by a conventional image conversion apparatus, for example, is an image that is recognized by a user as if the image entirely protrudes from a display surface of a display apparatus to the user's side. In this case, there has been a problem in that, although the user obtains a feeling of protrusion, the user feels the display surface of the display apparatus according to visual characteristics of a human being.

It is an object of the present invention to provide an image conversion apparatus that can generate, from a 2D image, a 3D image on which a user can visually recognize a sufficient spatial effect.

### Means for Solving the Problem

An image conversion apparatus according to a first aspect of the present invention converts non-stereoscopic image data into stereoscopic image data configured by left-eye image data and right-eye image data. The image conversion apparatus includes an input unit that inputs a non-stereoscopic image, and a conversion unit that generates and outputs the left-eye image data and the right-eye image data based on the non-stereoscopic image data input through the input unit. When a stereoscopic image configured by the left-eye image and the right-eye image is displayed on a display apparatus capable of displaying a stereoscopic image, the conversion unit generates the left-eye image data and the right-eye image data to cause a user to visually recognize the stereoscopic image so that a predetermined portion in a horizontal direction in the displayed stereoscopic image is present at a position farthest from the user in a direction vertical to a display surface of the display apparatus, and a portion other than the predetermined portion is present at a position closer to the user toward left and right ends of the stereoscopic image.

An image conversion apparatus according to a second aspect of the present invention converts non-stereoscopic image data into stereoscopic image data configured by left-eye image data and right-eye image data. The image conversion apparatus includes an input unit that inputs a non-stereoscopic image, and a conversion unit that generates and outputs the left-eye image data and the right-eye image data based on the non-stereoscopic image data input through the input unit. When a stereoscopic image configured by the left-eye image and the right-eye image is displayed on a display apparatus capable of displaying a stereoscopic image, the conversion unit generates the left-eye image data and the right-eye image data to cause a user to visually recognize the stereoscopic image so that the entire displayed stereoscopic image is present at a position farther than the display apparatus when viewed from the user in a direction vertical to a display surface of the display apparatus, a predetermined portion in the horizontal direction in a display region of the display apparatus is present at a closest position, and a portion other than the predetermined portion is present at a position farther from the user toward left and right ends of a stereoscopic image.

An image conversion apparatus according to a third aspect of the present invention processes stereoscopic image data. The image conversion apparatus includes an input unit that inputs a non-stereoscopic image, and a conversion unit that provides different moving distances to a left-eye image and a right-eye image of the stereoscopic image based on the stereoscopic image data input through the input unit to generate and output left-eye image data and right-eye image data. When differences between moving distances provided to left-eye image data and right-eye image data generated from the identical stereoscopic image data are compared with each other, the conversion unit generates the left-eye image data and the right-eye image data to make a difference between moving distances provided to a first pixel position of the stereoscopic image different from a difference between moving distances provided to a second pixel position different from the first pixel position.

### EFFECTS OF THE INVENTION

According to a first aspect of the present invention, when a stereoscopic image configured by the left-eye image and the right-eye image is displayed on a display apparatus capable of displaying a stereoscopic image, left-eye image data and right-eye image data are generated such that a user visually recognizes the stereoscopic image so that a predetermined portion in a horizontal direction in the displayed stereoscopic image is present at a position farthest from the user in a direction vertical to a display surface of the display apparatus and a portion other than the predetermined portion is present at a position closer to the user toward left and right ends of the stereoscopic image. Thus, a stereoscopic image (3D image) can be generated from a non-stereoscopic image (2D image), which can cause a user to feel sufficient depth perception and sufficient spatial perception and which can cause the user to feel the display surface of the display apparatus larger, because of the visual characteristics of a human being.

According to a second aspect of the present invention, when a stereoscopic image configured by the left-eye image and the right-eye image is displayed on a display apparatus capable of displaying a stereoscopic image, left-eye image data and right-eye image data are generated such that the user visually recognizes the stereoscopic image so that the entire displayed stereoscopic image is present at a position farther than the display apparatus when viewed from the user in a direction vertical to the display surface of the display apparatus, a predetermined portion in a horizontal direction in a display region of the display apparatus is present at a position closest to the user, and a portion other than the predetermined portion is present at a position farther from the user toward left and right ends of a 3D image. Thus, a stereoscopic image (3D image) can be generated from a non-stereoscopic image (2D image), which can cause the user to feel sufficient depth perception and sufficient spatial perception which can cause the user to feel a feeling of protrusion to user's side with respect to the predetermined portion, and which can cause the user to feel the display surface of the display apparatus larger, because of the visual characteristics of the human being.

According to a third aspect of the present invention, when differences between moving distances provided to left-eye image data and right-eye image data generated from the identical stereoscopic image data are compared with each other, left-eye image data and right-eye image data are generated such that a difference between moving distances provided to a first pixel position of the stereoscopic image is different from a difference between moving distances provided to a second pixel position different from the first pixel position. Thus, a 3D effect obtained in consideration of the visual characteristics of the human being can be provided.

### BRIEF DESCRIPTION OF DRAWINGS

FIG. 1 is a block diagram of a 3D image reproducing display system according to Embodiment 1.

FIG. 2 is a block diagram of a reproducing apparatus according to Embodiment 1.

FIG. 3 is a block diagram of a signal processor according to Embodiment 1.

FIGS. 4A and 4B are diagrams showing a timing at which a 2D image is converted into a 3D image in a memory and a video signal processor in Embodiment 1.

FIGS. 5A to 5C are diagrams for describing a parallax amount or the like between a left-eye image and a right-eye image in Embodiment 1.

FIGS. 6A to 6D are diagrams of a left-eye image and a right-eye image generated in Embodiment 1.

FIGS. 7A to 7D are diagrams for describing a parallax amount or the like between the left-eye image and the right-eye image in Embodiment 2.

FIGS. 8A to 8D are diagrams of a left-eye image and a right-eye image generated in Embodiment 2.

FIG. 9 is a diagram showing a timing at which a 2D image is converted into a 3D image in a memory and a video signal processor in Embodiment 3.

FIGS. 10A to 10D are diagrams of a left-eye image and a right-eye image generated in Embodiment 3.

FIGS. 11A to 11C are diagrams for describing a parallax amount or the like between the left-eye image and the right-eye image in Embodiment 3.

FIGS. 12A to 12C are diagrams for describing a parallax amount or the like between left-eye graphics and right-eye graphics in Embodiment 3.

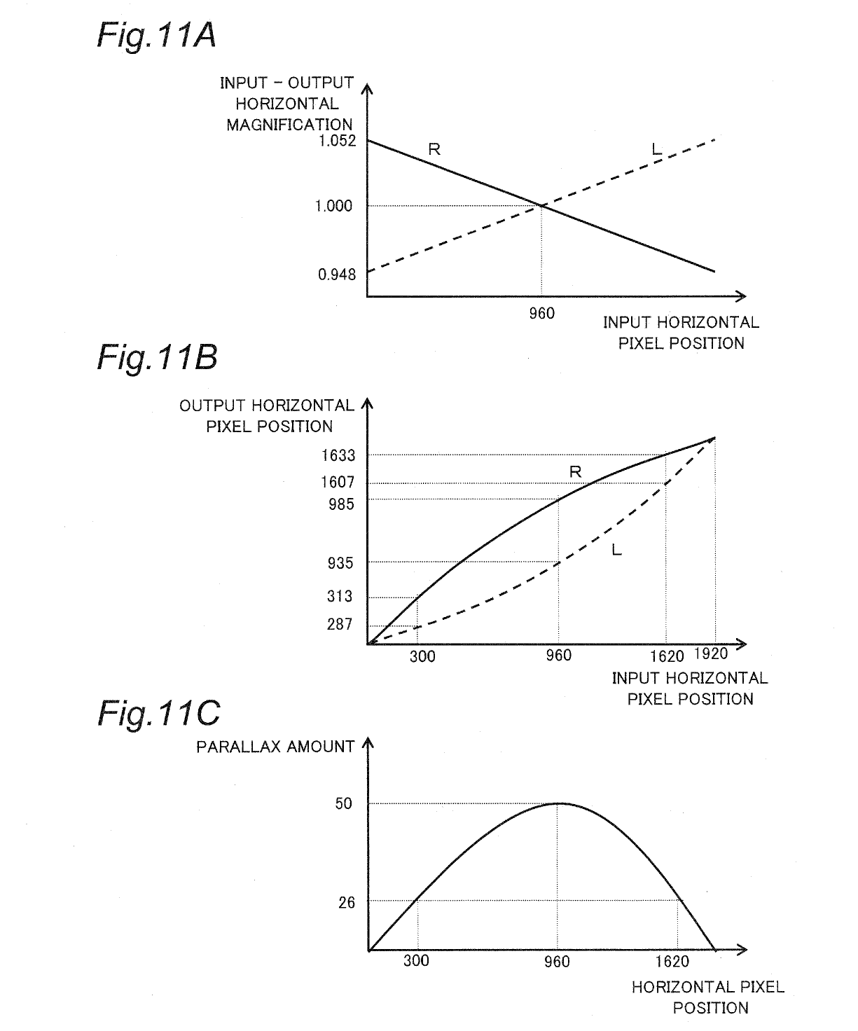

FIGS. 11A to 13D are diagrams of a left-eye image and a right-eye image generated in Embodiment 3.

### MODE FOR CARRYING OUT THE INVENTION

### Embodiment 1

1. Configuration

1. 1. Three-dimensional Stereoscopic Image Reproducing Display System

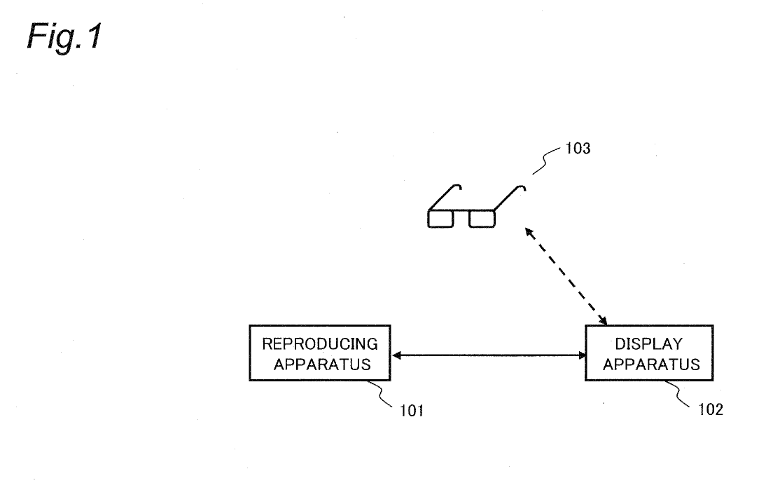

FIG. 1 shows a configuration of a three-dimensional stereoscopic image reproducing display system. The three-dimensional stereoscopic image reproducing display system includes a reproducing apparatus 101, a display apparatus 102, and 3D glasses 103. The reproducing apparatus 101 reproduces a three-dimensional stereoscopic image signal based on data recorded on a disk, and outputs the reproduced signal to the display apparatus 102. The display apparatus 102 displays a 3D image. More specifically, the display apparatus 102 alternately displays a left-eye image (hereinafter referred to as an “L image”) and a right-eye image (hereinafter referred to as an “R image”). The display apparatus 102 sends an image synchronization signal to the 3D glasses 103 by radio such as infrared. The 3D glasses 103 includes liquid crystal shutters at a left-eye lens portion and a right-eye lens portion, respectively, and alternately opens and closes the left and right liquid crystal shutters based on the image synchronization signal from the display apparatus 102. More specifically, when the display apparatus 102 displays an L image, the left-eye liquid crystal shutter opens, and the right-eye liquid crystal shutter closes. When the display apparatus 102 displays an R image, the right-eye liquid crystal shutter opens, and the left-eye liquid crystal shutter closes. With such a configuration, only the L image reaches the left eye and only the R image reaches the right eye of a user who wears the 3D glasses 103. Accordingly, the user can visually recognize a 3D image.

When a disk inserted into the reproducing apparatus 101 includes contents of a 2D image, the 2D image is converted into a 3D image to make it possible to output the 3D image. Details related to conversion from the 2D image to the 3D image will be described later.

1. 2. Reproducing Apparatus

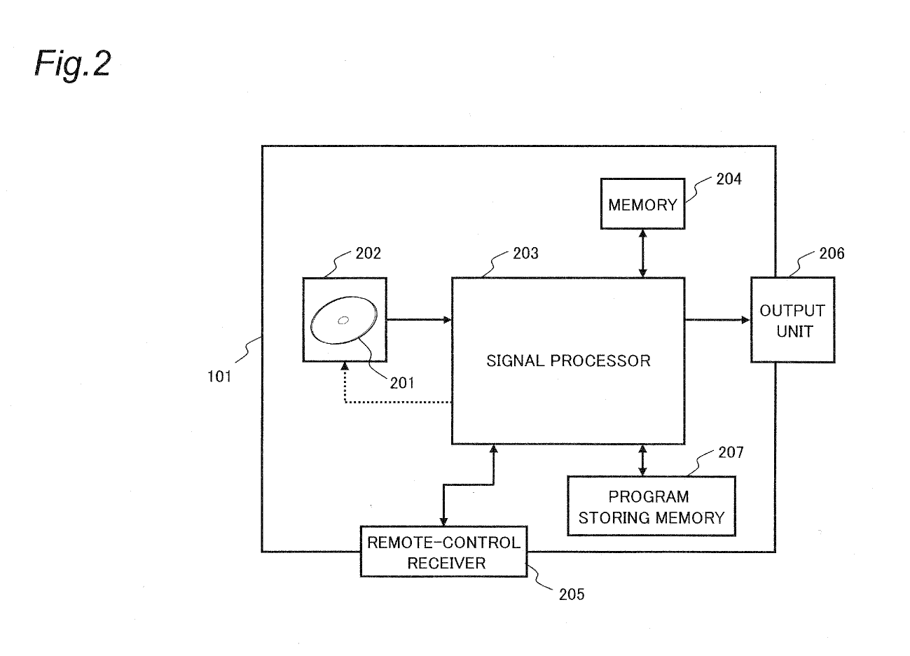

FIG. 2 shows a configuration of the reproducing apparatus 101. The reproducing apparatus 101 has a disk reproducing unit 202, a signal processor 203, a memory 204, a remote-control receiver 205, an output unit 206, and a program storing memory 207. The remote-control receiver 205 receives instructions of reproducing start, stop and correction of a protruding amount of a 3D image, an instruction for converting a 2D image into a 3D image, and the like from the user. In this case, a protruding amount of the 3D image is an amount (which may be a positive or negative value) representing the degree of protrusion obtained when a user who visually recognizes a 3D image visually recognizes the 3D image as if the 3D image protrudes from the display surface to the user's side in a direction vertical to the display surface of the display apparatus 102. The correction instruction of the protruding amount of the 3D image includes an instruction of a protruding amount of the entire 3D image and an instruction of a protruding amount of a part of the 3D image. In the correction instruction of the protruding amount of the 3D image, protruding amounts can be changed according to parts of the 3D image. The disk reproducing unit 202 reproduces a disk 201 on which data or the like of an image (video) such as a 2D image or a 3D image, sound (audio), graphics (letters, menu images, or the like), or the like are recorded. More specifically, the disk reproducing unit 202 reads the data to output a data stream. The signal processor 203 decodes data of an image, sound, graphics, or the like included in the data stream output from the disk reproducing unit 202, and temporarily stores the data in the memory 204. Furthermore, the signal processor 203 generates a device GUI stored in a memory 207 as necessary, and temporarily stores the device GUI in the memory 204. Data such as an image, sound, graphics, device GUI, or the like stored in memory 204 are subjected to a predetermined process in the signal processor 203 and the protruding amounts thereof are adjusted, to be output in a 3D format from the output unit 206.

When the contents recorded on the disk 201 are 2D contents configured by a 2D image, the signal processor 203 can convert the 2D contents into 3D contents configured by a 3D image and output the 3D contents. The details of the converting process will be described later.

1. 3. Configuration of Signal Processor

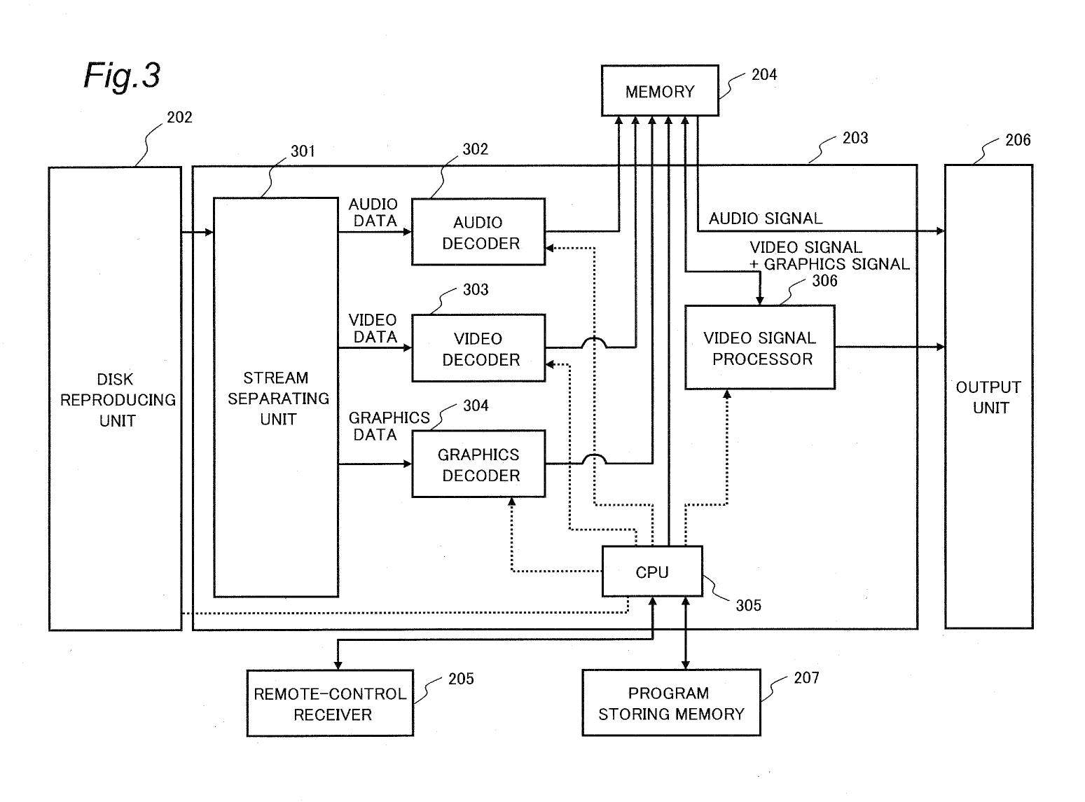

FIG. 3 shows a configuration of the signal processor 203. The signal processor 203 includes a stream separating unit 301, an audio decoder 302, a video decoder 303, a graphics decoder 304, a CPU 305, and a video signal processor 306.

The CPU 305 receives a reproducing start instruction by a user through the remote-control receiver 205 and causes the disk reproducing unit 202 to reproduce the disk 201. The stream separating unit 301 separates an image (video), sound, graphics, additional data including ID data, or the like included in the data stream output from the disk 201 in the disk reproducing unit 202. The audio decoder 302 decodes audio data read from the disk 201 and transfers the audio data to the memory 204. The video decoder 303 decodes video data read from the disk 201 and transfers the video data to the memory 204. The graphics decoder 304 decodes the graphics data read from the disk 201 and transfers the graphics data to the memory 204.

The CPU 305 reads GUI data of the device main body from the program storing memory 207 and generates and transfers the GUI data to the memory 204. The video signal processor 306 generates an L image and an R image by using the various types of data according to the determination by the CPU 305 and outputs the L image and the R image in a 3D image format.

2. 1. Converting Operation from 2D Image to 3D Image

When the contents recorded on the disk 201 are 2D contents configured by a 2D image, an operation in which the signal processor 203 converts the 2D image of the 2D contents into a 3D image and outputs the 3D image will be described. A stream including video data is input to the stream separating unit 301. The stream separating unit 301 outputs the video data of the 2D image to the video decoder 303. The video decoder 303 decodes the video data of the 2D image and transfers the video data to the memory 204. A video signal output from the video decoder 303 is a 2D video signal. The memory 204 records the video signal.

When the remote-control receiver 205 receives an instruction to convert a 2D image into a 3D image, the CPU 305 provides to the memory 204 and the video signal processor 306 an instruction to convert the 2D image into the 3D image and to output the 3D image. At this time, in order to generate a 3D image, the memory 204 outputs video signals of 2 frames representing the same 2D image for generating an L image and an R image of the 3D image. On the other hand, in order to convert the 2D image into the 3D image based on the instruction from the CPU 305, the video signal processor 306 performs different processings to image signals representing the same 2D image of the two frames output from the memory 204, generates image signals representing the L image and the R image configuring the 3D image, and outputs the generated image signals to the output unit 206.

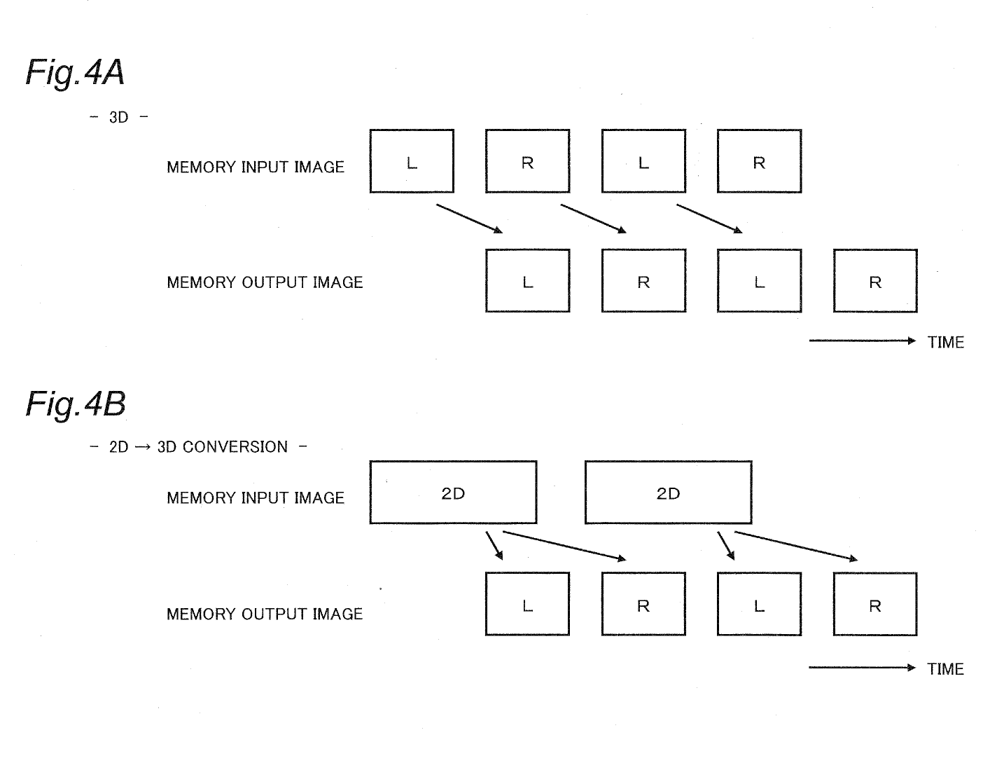

FIGS. 4A and 4B are diagrams showing a timing at which a video signal is input from the video decoder 303 to the memory 204 and a timing at which the video signal is output from the memory 204. FIG. 4A shows a case in which an image represented by the input video signal is a 3D image, and FIG. 4B shows a case in which an image represented by the input video signal is a 2D image and the 2D image is converted into a 3D image to be output. A horizontal direction in FIGS. 4A and 4B denotes passage of time. In the following description, for convenience of description, an image represented by a video signal input to the memory 204 is simply called an “image input to the memory 204” or a “memory input image”, and an image represented by a video signal output from the memory 204 is simply called an “image output from the memory 204” or a “memory output image”. Graphics represented by a graphics signal input to the memory 204 are simply called “graphics input to the memory 204” or “memory input graphics”, and graphics represented by a graphics signal output from the memory 204 are simply called “graphics output from the memory 204” or “memory input graphics”. When an image input to the memory 204 is a 3D image, an L image and an R image configuring the 3D image are alternately input. After a predetermined period of time has passed after the images are input, the L image and the R image are alternately output, and output to the video signal processor 306. The video signal processor 306 performs processings on the input L and R images, thereby being capable of changing a 3D effect. In contrast, when an image input to the memory 204 is a 2D image, the same 2D image is output twice as an L image generating image and an R image generating image, and input to the video signal processor 306. The video signal processor 306 performs different image processings to the L image generating image and the R image generating image to generate an L image and an R image configuring a 3D image.

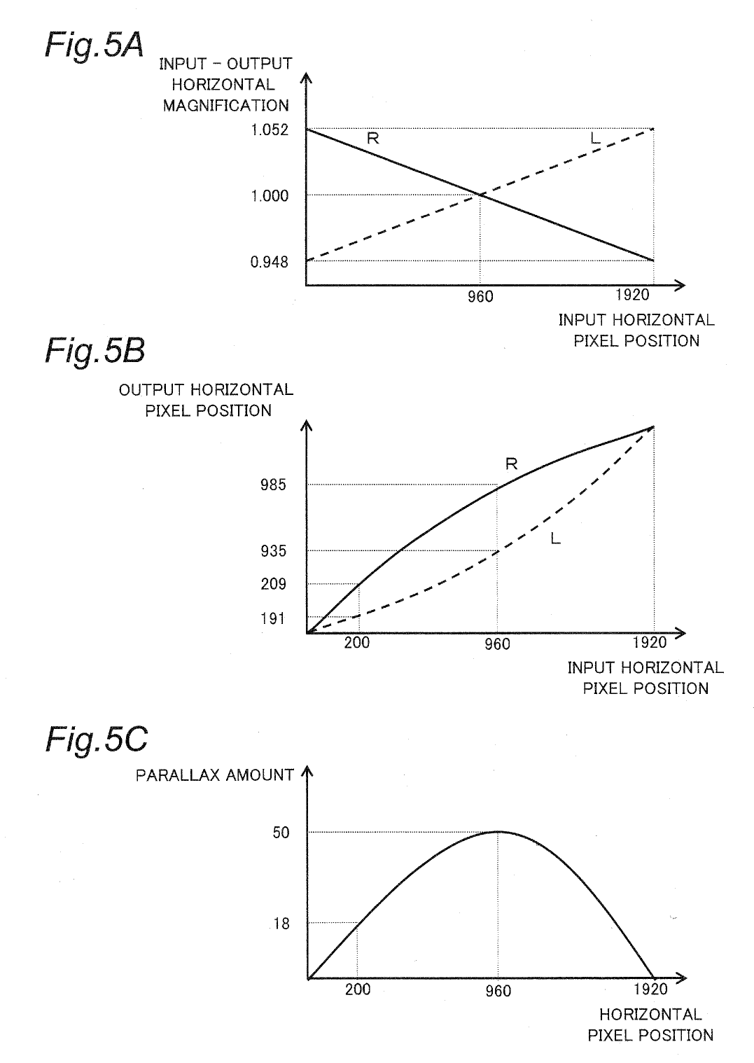

FIGS. 5A to 5C shows an example of processing performed to an input 2D image by the video signal processor 306 when the 2D image is input to the video signal processor 306. FIG. 5A is a diagram showing a relationship between a horizontal pixel position of a 2D image input to the video signal processor 306 and a magnification (input-output horizontal magnification) in a horizontal direction to the input image. FIG. 5B is a diagram showing a relationship between the horizontal pixel position of the 2D image input to the video signal processor 306 and a horizontal pixel position of a 3D image (L image and R image) output from the video signal processor 306. FIG. 5C is a diagram showing a relationship between the horizontal pixel position of a 3D image (L image and R image) and a parallax amount between the L image and the R image.

As indicated by a broken line in FIG. 5A, an input-output horizontal magnification to generate the L image is set to be increased at a predetermined inclination with an increase in value of the input horizontal pixel position. More specifically, a horizontal magnification for the L image is set to 0.948 at a horizontal left end (position of the virtual 0th pixel on the immediate left of the first pixel, hereinafter referred to as a “0th pixel”), 1.0 at a 960th pixel at the center in the horizontal direction, and 1.052 at a 1920th pixel at a horizontal right end, and increases at a predetermined inclination. With the above settings, an average magnification of the 0th pixel to the 1920th pixel is 1.0. On the other hand, a horizontal magnification for the R image, in contrast to the horizontal magnification for the L image, is set to be decreased at a predetermined inclination with an increase of the input horizontal pixel position. For example, the horizontal magnification for the L image is set to 1.052 at the 0th pixel, 1.0 at a 960th pixel at the center in the horizontal direction, and 0.948 at the 1920th pixel at the horizontal right end, and decreases at a predetermined inclination. With the above settings, an average magnification of the 0th pixel to the 1920th pixel is 1.0.

When a magnifying process is performed to the L image and the R image with the horizontal magnification shown in FIG. 5A, positions of pixels of the input image are converted (moved) to positions indicated by output horizontal pixel positions in FIG. 5B in the output image.

First, a case in which a magnifying process is performed to the L image will be described. As shown in FIG. 5A, the horizontal magnification for the L image is set to 0.948 at the 0th pixel at the horizontal left end and 1.052 at the 1920th pixel at the horizontal right end, and increases at a predetermined inclination. For this reason, as shown in FIG. 5B, the value representing the output horizontal pixel position is smaller than a value representing a corresponding input horizontal pixel position. For example, when the input horizontal pixel position is 200, the output horizontal pixel position is 191. When the input horizontal pixel position is 960, the output horizontal pixel position is 935. This means that the output horizontal pixel position shifts to the left of the input horizontal pixel position. A shift amount becomes 0 at the 0th pixel at the left end of the input image. In the range from the left end position to a central position (position of the 960th pixel (position at which the horizontal magnification is 1)) in the horizontal direction of the input image, since the horizontal magnification is smaller than 1, the shift amount increases as the pixel position comes close to the right end, and becomes maximum at the central position in the horizontal direction of the input image. In the range from the central position to the right end (the 1920th pixel) of the input image, since the horizontal magnification is larger than 1, the shift amount decreases as the pixel position comes close to the right end, and becomes 0 at the right end (the 1920th pixel) of the input image.

Next, a case in which a magnifying process is performed to the R image will be described. As shown in FIG. 5A, a horizontal magnification for the R image is set to reverse values of the horizontal magnification for the L image. More specifically, the horizontal magnification for the R image is set to 1.052 at the 0th pixel at the horizontal left end and 0.948 at the 1920th pixel at the horizontal right end, and decreases at a predetermined inclination. For this reason, as shown in FIG. 5B, the value representing the output horizontal pixel position is larger than a value representing a corresponding input horizontal pixel position. For example, when the input horizontal pixel position is 200, the output horizontal pixel position is 209. When the input horizontal pixel position is 960, the output horizontal pixel position is 985. This means that the output horizontal pixel position shifts to the right of the input horizontal pixel position. A shift amount becomes 0 at the 0th pixel at the left end of the input image. In the range from the left end position to a central position (position of the 960th pixel (position at which the horizontal magnification is 1)) in the horizontal direction of the input image, since the horizontal magnification is larger than 1, the shift amount increases as the pixel position comes close to the right end, and becomes maximum at the central position in the horizontal direction of the input image. In the range from the position to the right end (the 1920th pixel) of the input image, since the horizontal magnification is smaller than 1, the shift amount decreases as the pixel position comes close to the right end, and becomes 0 at the right end (the 1920th pixel) of the input image.

A difference between the output horizontal pixel position of the L image and the output horizontal pixel position of the R image, i.e., a parallax amount is shown in FIG. 5C. In FIG. 5C, the horizontal axis denotes an input horizontal pixel position, and the vertical axis denotes a parallax amount. A 3D image generated by an L image and an R image having a parallax amount that changes as shown in FIG. 5C is an image that is recognized by a user as if the central portion in the horizontal direction is present at a position farthest from the user in a direction vertical to the display surface of the display apparatus 102 (hereinafter, this “far position” is appropriately referred to as “on the rear”. The opposite direction is appropriately referred to as “on the front”) and a portion other than the central portion in the horizontal direction is present at a position (on the front) closer to the user toward the left and right end of the stereoscopic image. As shown in FIG. 5C, the parallax amount between the L image and the R image in the 3D image is 0 at both the ends (the first pixel and the 1920th pixel) in the horizontal direction, and is maximum at the center in the horizontal direction. That is, the input 2D image is converted into an L image and an R image that generate a curved 3D image recognized by a user as if a central portion in the horizontal direction is present on the rear of both the ends in the horizontal direction.

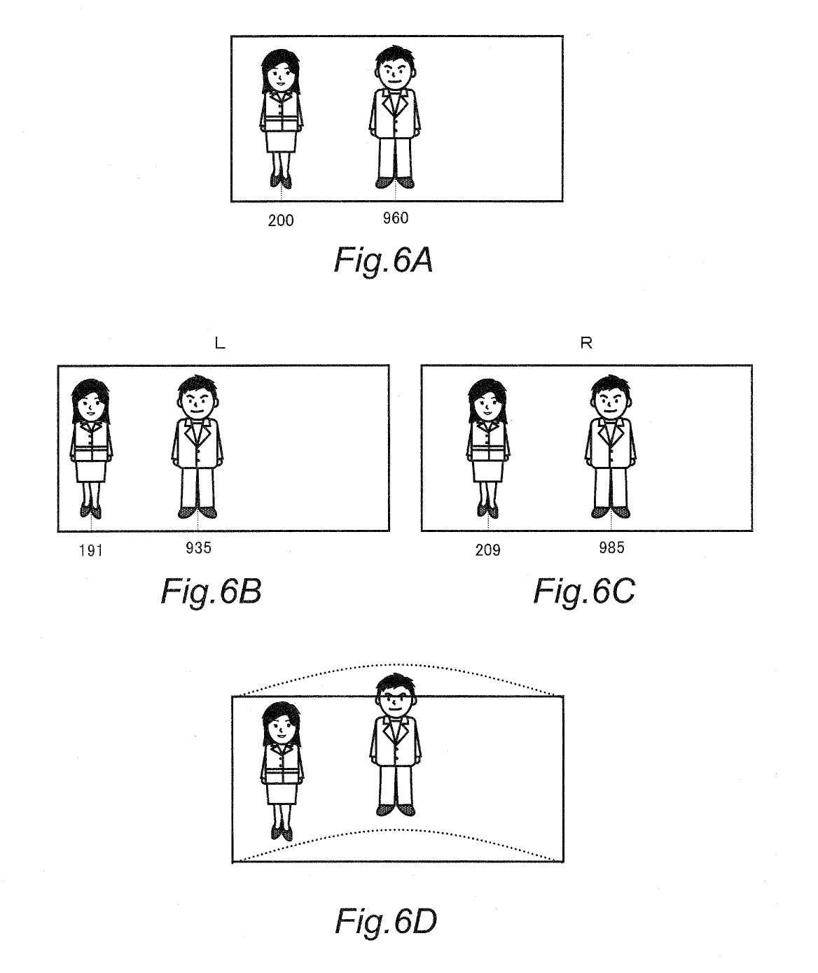

FIGS. 6A to 6D are diagrams showing a manner of converting the input 2D image into a 3D image based on the characteristics shown in FIGS. 5A to 5C. FIG. 6A shows an example of a 2D image input to the video signal processor 306 and having horizontal 1920 pixels. FIG. 6B and 6C shows an L image and an R image obtained when processing based on the characteristics shown in FIGS. 5A to 5C is performed. The 200th pixel in the input 2D image is moved to the 191st pixel in the L image and moved to the 209th pixel in the R image. As a result, a 16-pixel parallax is generated between the R image and the L image. On the other hand, the 960th pixel located near the center in the horizontal direction in the input 2D image is moved to the 935th pixel in the L image and moved to the 985th pixel in the R image. As a result, 50-pixel parallax is generated between the R image and the L image. That is, between the generated R and L images, a parallax amount near the center in the horizontal direction is larger than parallax amounts near both the ends in the horizontal direction. Thus, as shown in FIG. 6D, a 3D image visually recognized by a user through the 3D glasses 103 is an image recognized by the user such that positions in the depth direction of both the horizontal end portions serving as a curved image is located at substantially the same position as that of the display surface of the display apparatus 201, and a horizontal central portion is present on the rear side of both the horizontal end portions on a curved surface.

As described above, in the reproducing apparatus 101 according to this embodiment, moving distances of pixels are changed depending on input horizontal pixel positions. In this embodiment, the L image data and the R image data are generated to cause a user to visually recognize a stereoscopic image configured by an L image and an R image, when the stereoscopic image is displayed on the display apparatus 102 capable of displaying a 3D image, so that the central portion in the horizontal direction in the displayed 3D image is present at a position farthest from the user in a direction vertical to the display surface of the display apparatus 102, and a portion other than the horizontal central portion is present at a position farther from the user toward both the left and right ends of the stereoscopic image. The parallax amount may be changed stepwise instead of being continuously changed.

When the L image and the R image are generated from the 2D image by the image converting method, the converted L and R images look like a pseudo 3D image according to the visual characteristics of the human being. In the image converting method, since the 2D image is only extended or reduced in the horizontal direction, the image can be prevented from being broken down.

Depending on a protruding amount correcting instruction received by the remote-control receiver 205 and an instruction of converting a 2D image into a 3D image, the CPU 305 may adjust a protruding amount of the 3D image generated by the video signal processor 306.

When the protruding amount of the entire image is adjusted, the characteristics shown in FIG. 5B change. More specifically, when a protruding amount is adjusted to cause a user to recognizes an image so that the image is present on the front of a 3D image displayed based on the characteristics shown in FIGS. 5A to 5C, a conversion curve of the L image parallelly shifts upward in an vertical axis direction, and a conversion curve of the R image parallelly shifts downward in the vertical axis direction. In this case, the characteristics in FIG. 5C parallelly shift downward along the vertical axis. On the other hand, when the adjustment is performed to cause the user to recognize an image so that the image is present on a further rear side, the conversion curve of the L image parallelly shifts upward in the vertical axis direction, and the conversion curve of the R image parallelly shifts downward in the vertical axis direction. In this case, the values of the graph in FIG. 5C parallelly shift upward along the vertical axis.

As a method of adjusting a protruding amount of a part of the image, there is a method of adjusting a horizontal magnification while maintaining an average value of the horizontal magnifications in FIG. 5A at a constant magnification. For example, when the horizontal magnification is increased, absolute values of inclinations of straight lines R and L in FIG. 5A only need to be increased. In this case, a difference between output horizontal pixel positions on curves R and L in FIG. 5B increases. At this time, the maximum value of a parallax amount indicated by the curve in FIG. 5C is increased. In this case, there is obtained a 3D image having an improved depth perception than the 3D image before the adjustment. When the horizontal magnification is reduced, absolute values of inclinations of the straight lines R and L in FIG. 5A only need to be reduced. In this case, the difference between the output horizontal pixel positions on the curves R and L in FIG. 5B decreases. At this time, a parallax amount decreases, and the maximum value of a parallax amount indicated by the curve in FIG. 5C decreases. In this case, there is obtained a 3D image having a poorer depth perception than the 3D image before the adjustment. As above, in this embodiment, the protruding amount can be adjusted depending on the instruction received by the remote-control receiver 205.

3. Conclusion

In this embodiment, the reproducing apparatus 101 includes the stream separating unit 301 that receives a 3D image and the video signal processor 306 that generates and outputs L image data and R image data based on 2D image data input from the stream separating unit 301. The video signal processor 306 generates L image data and R image data to cause a user to visually recognize the image when a 3D image configured by an L image and an R image is displayed on the display apparatus 102 capable of displaying a 3D image so that the central portion in the horizontal direction in the displayed 3D image is present at a position farthest from the user in a direction vertical to the display surface of the display apparatus 102, and a portion other than the central portion is present at a position farther from the user toward both the left and right ends of the stereoscopic image.

With such a simple configuration, there can be generated a 3D image from a 2D image, which can cause a user to feel sufficient depth perception and sufficient spatial perception according to the visual characteristics of the human being and which can cause the user to feel as if the display surface of the display apparatus 102 is larger.

The video signal processor 306 generates L image data and R image data to cause a user to recognize a 3D stereoscopic image configured by an L image and an R image when the 3D stereoscopic image is displayed on the display apparatus 102 capable of displaying a 3D image so that the entire displayed 3D image is present at a position farther from the display surface of the display apparatus 102 when viewed from the user in a direction vertical to the display surface of the display apparatus 102.

According to the stereoscopic image realized with the above configuration, the user is caused to more strongly feel depth perception and spatial perception according to the visual characteristics of the human being.

In this embodiment, although the image is configured to be recognized by a user so that the substantial central portion in the horizontal direction is present at the farthest position, the image may be configured to be recognized by the user so that a portion other than the central portion is present at the farthest position. Also in this case, the same effect can be obtained.

A position at which a 3D image is recognized by the user in a direction vertical to the display surface of the display apparatus 102 may be configured to be adjustable with a remote controller. A signal from the remote controller is received by the remote-control receiver 205 and processed by the signal processor 203. With this configuration, a 3D image according to the user's preferences can be generated.

### Embodiment 2

In Embodiment 1, L image data and R image data are generated to cause a user to visually recognize the image so that a central portion in a horizontal direction in a displayed 3D image is present at a position farthest from the user (most rear side), and a portion other than the central portion is present at a position closer to the user (on the front) toward left and right ends. In contrast, in Embodiment 2, an image is displayed to cause a user to visually recognize an image so that a displayed entire 3D image is present at a position farther than the display surface of the display apparatus 102 when viewed from the user, a central portion in a horizontal direction in a display region of the display apparatus 102 is present at the closest position, and present at a position closer to the user toward left and right ends of the stereoscopic image at the central position. The configuration of the reproducing apparatus 101 is the same as that in Embodiment 1. A configuration of Embodiment 2 will be described below in detail.

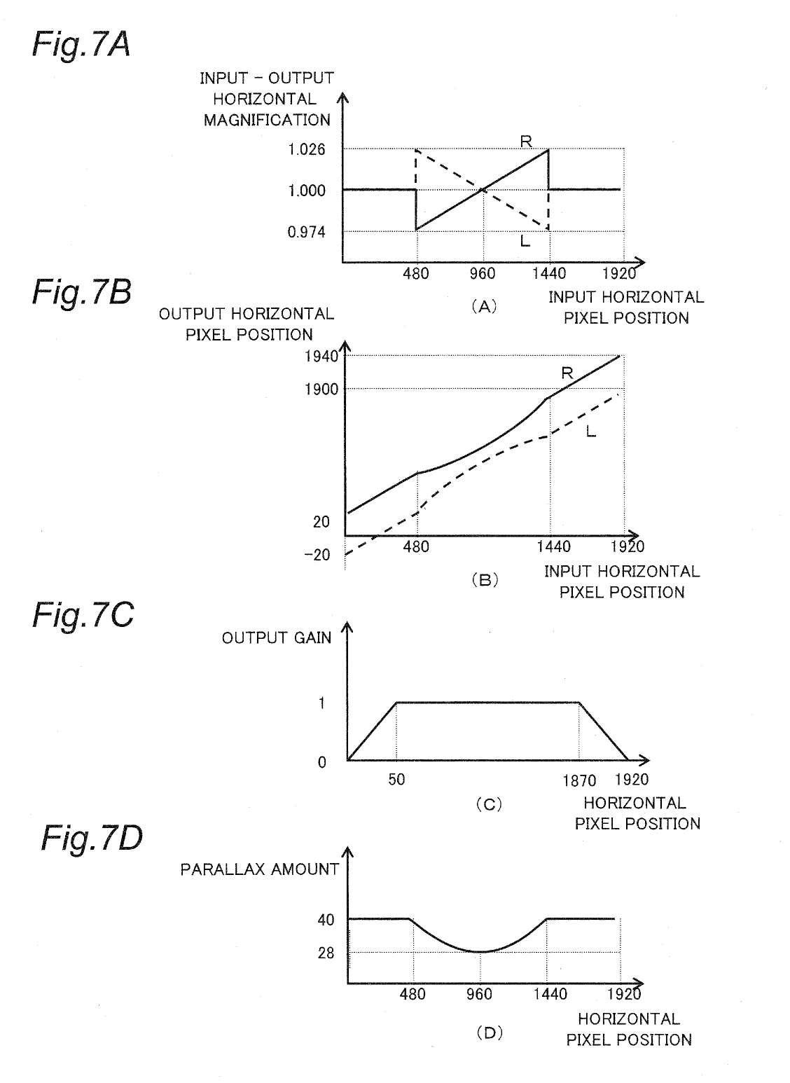

FIGS. 7A to 7D show an example of processing performed to an input 2D image by the video signal processor 306 when a 2D image is input to the video signal processor 306. FIG. 7A is a diagram showing a relationship between a horizontal pixel position of a 2D image input to the video signal processor 306 and a magnification (input-output horizontal magnification) in a horizontal direction to the input image. FIG. 7B is a diagram showing a relationship between the horizontal pixel position of the 2D image input to the video signal processor 306 and a horizontal pixel position of a 3D image (L image and R image) output from the video signal processor 306. FIG. 7C is a diagram showing a relationship between the horizontal pixel position of a 3D image (L image and R image) and an output gain. FIG. 7D is a diagram showing a relationship between the horizontal pixel position of a 3D image (L image and R image) and a parallax amount between the L image and the R image.

Embodiment 2 is different from Embodiment 1 in that a region in which a horizontal magnification is changed in FIG. 7A is limited to a region near the center in a horizontal direction in an input image, a horizontal magnification for protruding an L image in the region near the center in the horizontal direction is reduced from 1.026 to 0.974, and a horizontal magnification is increased from 0.974 to 1.026 with respect to an R image. With this configuration, the input 2D image is converted into a 3D image that is recognized by a user so that the entire displayed 3D image is present on the rear of the display surface of the display apparatus 102, and a predetermined portion in the horizontal direction in the display region of the display apparatus 102 is present in the forefront and stepwise or continuously present on the rear from the predetermined position toward the left and right ends.

In Embodiment 2, based on the horizontal magnification shown in FIG. 7A, an L image generated from the 2D image is shifted to the left, and an R image is shifted to the right. For example, a first pixel of the input 2D image (image) is converted into the −19th pixel in the L image, and the 1920th pixel is output as the 1900th pixel. On the other hand, the first pixel of the input 2D image is output as the 21st pixel in the R image, and the 1920th pixel is output as the 1940th pixel. However, since the display apparatus 102 can display only the first pixel to the 1920th pixel, the video signal processor 306 outputs only the first pixel to the 1920th pixel as a final output. For this reason, a part of the L image lacks at the left end of the display surface (screen) of a display apparatus 10, and a part of the R image lacks at the right end of the screen.

When the 3D image has a parallax at both the ends in the horizontal direction, a part of the L image or the R image is out of the display area and lacks, thereby making a user uncomfortable. In this embodiment, in order to reduce the uncomfortable feeling, as shown in FIG. 7C, an amplitude is corrected when the L image and the R image are output. The horizontal axis in FIG. 7C indicates a horizontal pixel position of a 3D image (output image), and the vertical axis indicates a gain of the amplitude of the output image. The gain is set to 1 in an intermediate portion (from the 50th pixel to the 1870th pixel) except for portions near both the ends in the horizontal direction, set to 0 at both the ends, and changes at a predetermined inclination between the intermediate portion and both the ends. The number of pixels between both the ends and the intermediate portion is set to a value larger than the maximum parallax amount. The gain is reduced from 1 to 0 from the intermediate position to both the ends as above, thereby causing the brightness of the image to gradually decrease from the intermediate portion to both the ends. Accordingly, the uncomfortable feeling occurring when a part of the L image or the R image lacks in the both the horizontal end portions can be reduced.

In this embodiment, although the parallax amount between the L image and the R image, as shown in FIG. 7D, is constant on both the horizontal end sides, the parallax amount changes to be smaller than the value in the intermediate range between both the ends. More specifically, the parallax amount is set such that the image appears to be recessed from the display surface on both the horizontal end sides, and appears to roundly protrude from both the end sides inside the both the end sides.

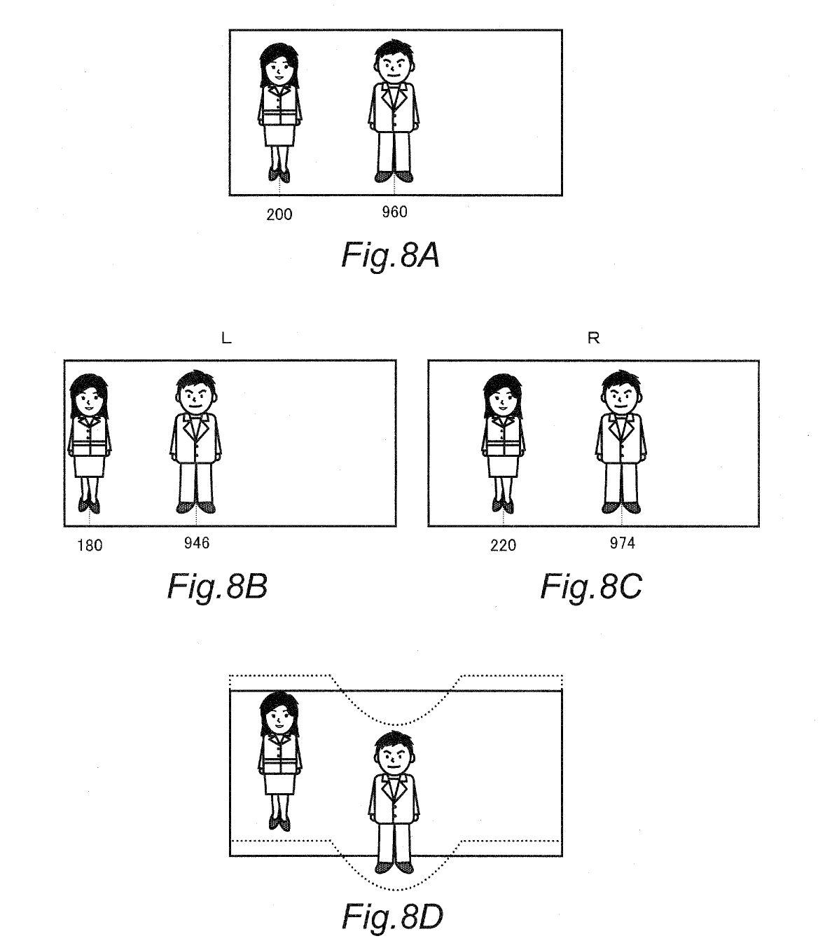

FIGS. 8A to 8D are diagrams showing a manner of converting an input image into a 3D image based on the characteristics shown in FIGS. 7A to 7D. FIG. 8A shows an example of a 2D image input to the video signal processor 306 and having horizontal 1920 pixels. In the input 2D image, the number of horizontal pixels is 1920. FIGS. 8B and 8C show an L image and an R image obtained when processing based on the characteristics shown in FIGS. 7A to 7D is performed. The 200th pixel in the input 2D image is moved to the 180th pixel in the L image and moved to the 220th pixel in the R image. As a result, a 40-pixel parallax is generated between the R image and the L image. On the other hand, the 960th pixel located near the center in the horizontal direction in the input 2D image is moved to the 946th pixel in the L image and moved to the 974th pixel in the R image. As a result, 26-pixel parallax is generated between the R image and the L image. Near the center in the horizontal direction in the generated 3D image, an absolute value of the parallax amount is smaller than that on both the horizontal end sides. Thus, as shown in FIG. 8D, a 3D image visually recognized by a user through the 3D glasses 103 is an image recognized by the user so that the entire displayed 3D image is present on the rear of the display surface of the display apparatus 102, a central portion in the horizontal direction in the display region of the display apparatus 102 is present in the forefront, and stepwise or continuously present on the rear from the central portion toward the left and right ends.

As described above, in Embodiment 2, the reproducing apparatus 101 includes the stream separating unit 301 that receives a 3D image and the video signal processor 306 that generates and outputs L image data and R image data based on 2D image data input from the stream separating unit 301. The video signal processor 306 generates L image data and R image data to cause a user to visually recognize a 3D image configured by an L image and an R image when the 3D image is displayed on the display apparatus 102 capable of displaying a 3D image, so that the entire displayed 3D image is present at a position farther than the display apparatus 102 when viewed from the user in a direction vertical to the display surface of the display apparatus 102, a central portion in the horizontal direction in the display region of the display apparatus 102 is present at the closest position, and a portion other than the central portion is present at a position farther from the user toward both the left and right ends of the stereoscopic image.

With the stereoscopic image realized by the above configuration, there can be generated a 3D image that can cause a user to feel sufficient depth perception and sufficient spatial perception according to the visual characteristics of the human being, can cause the user to feel a feeling of protrusion to the user's side with respect to a central portion, and can cause the user to feel as if the display surface of the display apparatus 102 larger.

In this embodiment, the video signal processor 306 reduces image amplitudes at ends of the L image and the R image. With this manner, the uncomfortable feeling occurring when a part of the L image or the R image lacks in the both the horizontal end portions of the 3D image can be reduced. This technical idea and a technical idea of another embodiment (to be described later) related thereto can also be applied to Embodiment 1.

### Embodiment 3

In Embodiment 3, a 2D image is converted into a 3D image based on the same characteristics as those in Embodiment 1, and graphics data is 3-dimensionalized based on the same characteristics as those in Embodiment 1, the 3-dimensionalized data is superposed to the 3D image to display. The configuration of the reproducing apparatus 101 is the same as that in Embodiment 1.

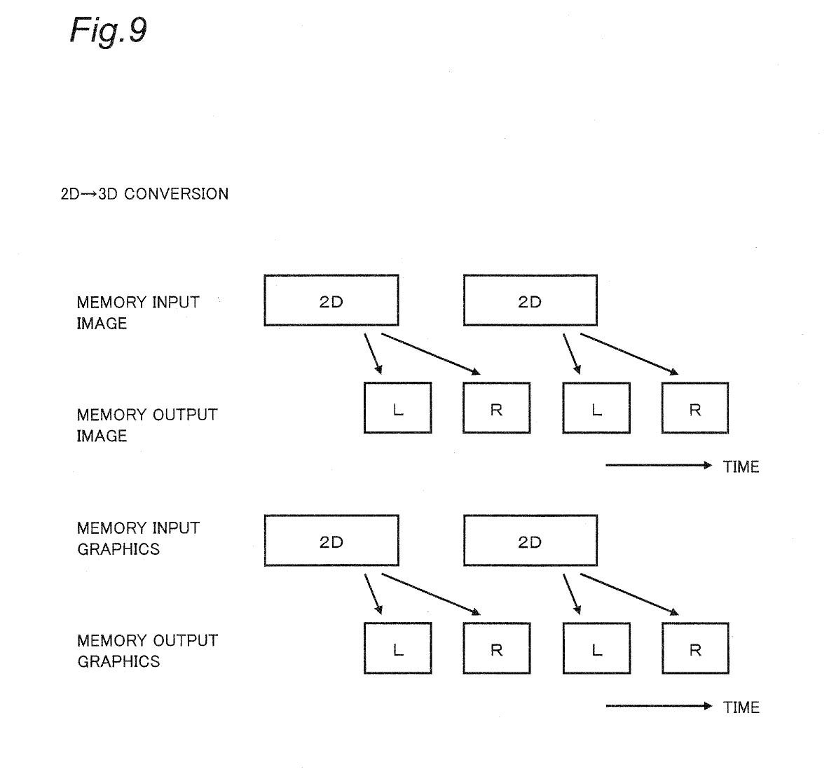

FIG. 9 shows a timing at which an image and graphics are input to the memory 204 and a timing at which an image and graphics are output from the memory 204. FIG. 9 shows a case in which an input image is a 2D image and is converted into a 3D image and output the 3D image. A horizontal direction in FIG. 9 shows passage of time. A memory input image shows an image input to the memory 204. A memory output image shows an image output from the memory 204. Memory input graphics show graphics data such as caption data input to the memory 204. Memory output graphics show output graphics data output from the memory 204. The same 2D image and the same graphics data are output twice as an L image generating image and graphics data and an R image generating image and graphics data, respectively, and input to the video signal processor 306. The video signal processor 306 makes processing contents to the L image generating image and processing contents to the R image generating image different from each other to generate an L image and an R image configuring a 3D image.

Embodiment 3 is different from Embodiment 1 and Embodiment 2 in that not only processing for a video signal but also processing for a graphics signal are performed as processing contents in the video signal processor 306. The processing contents in the video signal processor 306 can be independently performed to the video signal and the graphics signal so that a front-and-back positional relationship between the generated 3D image and the graphics can be changed.

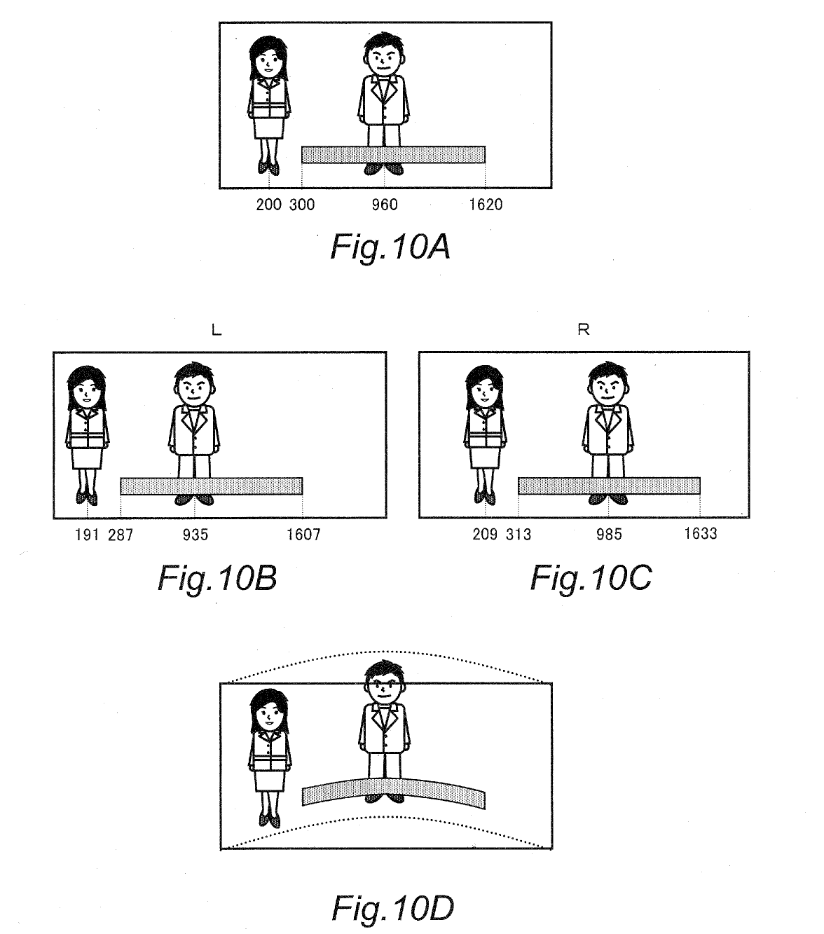

In Embodiment 3, in the video signal processor 306, the same signal processing as that in Embodiment 1 is performed to the 3D image and the graphics. FIGS. 10A to 10D show a manner of converting an image and graphics with this processing. Note that, after the image and the graphics are combined with each other, the same signal processing as that in Embodiment 1 may be performed.

FIG. 10A shows an example of an image obtained by combining the 2D image input to the video signal processor 306 and having horizontal 1920 pixels to the graphics. FIGS. 10B and 10C show an L image and an R image obtained when an image and graphics are combined with each other after the processing in FIGS. 5A to 5C is performed to the image. The 200th pixel in the input 2D image is moved to the 191st pixel in the L image and moved to the 209th pixel in the R image. As a result, a 16-pixel parallax is generated between the R image and the L image. On the other hand, the 960th pixel located near the center in the horizontal direction in the input 2D image is moved to the 935th pixel in the L image and moved to the 985th pixel in the R image. As a result, 50-pixel parallax is generated between the R image and the L image. That is, between the generated R and L images, a parallax amount near the center in the horizontal direction is larger than parallax amounts near both the ends in the horizontal direction. Thus, as shown in FIG. 10D, a 3D image visually recognized by a user through the 3D glasses 103, is an image visually recognized by the user such that both horizontal end portions are substantially near the display surface of the display apparatus 201, and a horizontal central portion is present on the rear of both the horizontal end portions on a curved surface.

FIGS. 11A to 11C show an example of processing performed to graphics data by the video signal processor 306 when the graphics data is input to the video signal processor 306. FIG. 11A is a diagram showing a relationship between a horizontal pixel position of graphics input to the video signal processor 306 and a magnification (input-output horizontal magnification) in a horizontal direction to the input graphics. FIG. 5B is a diagram showing a relationship between the horizontal pixel position of the 2D graphics input to the video signal processor 306 and a horizontal pixel position of 3D graphics (L image and R image) output from the video signal processor 306. FIG. 5C is a diagram showing a relationship between the horizontal pixel position of 3D graphics (L image and R image) and a parallax amount between the L image and the R image. The characteristics shown in FIGS. 11A, 11B, and 11C are the same as the characteristics shown in FIGS. 5A, 5B, and 5C.

When a 3D converting process is performed based on the characteristics shown in FIGS. 11A, 11B, and 11C, as shown in FIGS. 10A to 10D, the 300th pixel configuring the left end of the input graphics is moved to the 287th pixel in the L image and moved to the 313th pixel in the R image. As a result, a 26-pixel parallax is generated between the R image and the L image. On the other hand, the 1620th pixel configuring the right end of the input graphics is moved to the 1607th pixel in the L image and moved to the 1633rd pixel in the R image. As a result, a 26-pixel parallax is generated between the R image and the L image. Since processing having the same characteristics as those of the input 2D image is performed to the input graphics, the graphics appear to be stuck to an image subjected to curved surface conversion.

As described above, according to the reproducing apparatus 101 of Embodiment 3, not only the 2D image, but also the graphics data can be 3-dimensionalized and displayed. Thus, a 3D effect can also be obtained with respect to the graphics data. In particular, in this embodiment, since the 3D conversion characteristics of the graphics data are the same as those of the 2D image, there can be obtained a 3D image that appears to be obtained by sticking the graphics and the image to each other. As in Embodiments 1 and 2, both the graphics and the image can cause a user to feel sufficient depth perception and sufficient spatial perception according to the visual characteristics of the human being.

### Embodiment 4

In Embodiment 4, although a 2D image is converted into a 3D image based on the same characteristics as those in Embodiment 1, the graphics data is 3-dimensionalized so as not to be curved as in Embodiment 3, and is superimposed and displayed. The configuration of the reproducing apparatus 101 is the same as that in Embodiment 1.

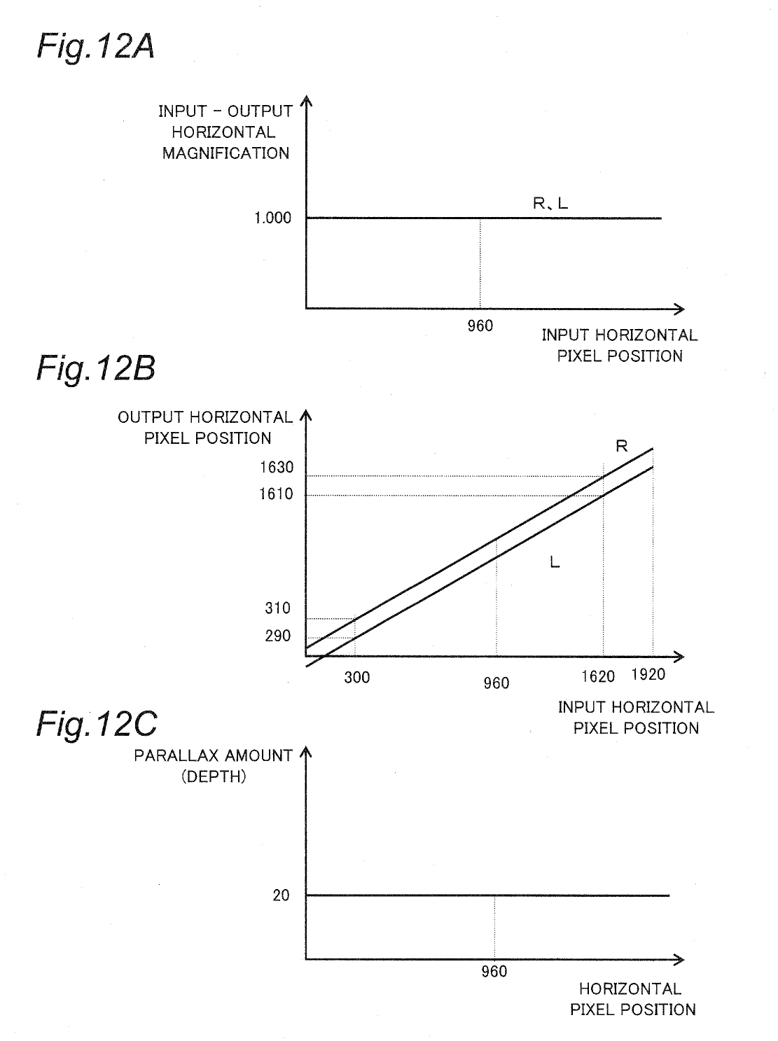

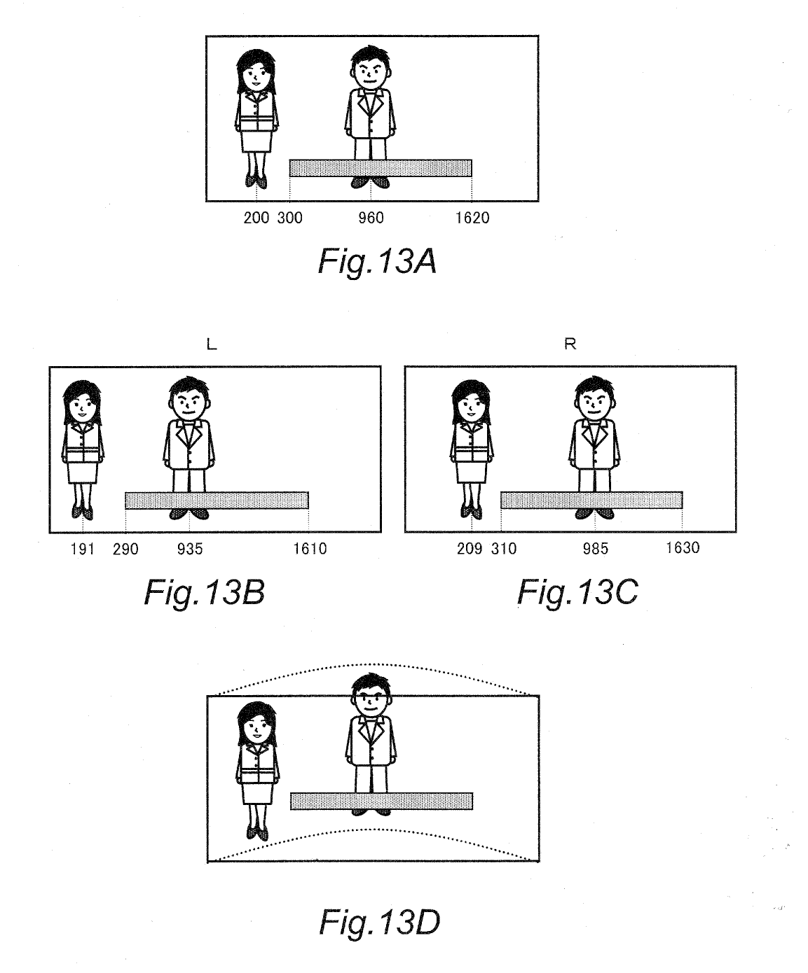

In Embodiment 4, there will be described a case in which processing to the graphics data performed by the video signal processor 306 in Embodiment 3 is changed from processing based on the characteristics shown in FIGS. 10A to 10D to processing based on the characteristics shown in FIGS. 12A to 12C. Note that processing to the 2D image in the video signal processor 306 is performed based on the characteristics shown in FIGS. 5A to 5C.

FIG. 12A is a diagram showing a relationship between a horizontal pixel position of graphics input to the video signal processor 306 and a magnification (input-output horizontal magnification) in a horizontal direction to the input graphics. FIG. 12B is a diagram showing a relationship between the horizontal pixel position of the 2D graphics input to the video signal processor 306 and a horizontal pixel position of the 3D graphics (L image and R image) output from the video signal processor 306. FIG. 12C is a diagram showing a relationship between the horizontal pixel position of the 3D graphics (L image and R image) and a parallax amount between the L image and the R image.

In this embodiment, as shown in FIG. 12A, the horizontal magnification is fixed to 1 in both the L image and the R image. As shown in FIG. 12B, an output horizontal pixel position is shifted by 10 pixels with reference to an input pixel position in generation of an L image, and the output horizontal pixel position is shifted to the right by 10 pixels with reference to the input pixel position in generation of an R image. As shown in FIG. 12C, a parallax amount is 20 pixels regardless of the horizontal pixel position.

FIGS. 13A to 13D are diagrams showing a manner of converting the input 2D image and the graphics into a 3D image based on the characteristics shown in FIGS. 5A to 5C and FIGS. 12A to 12C. FIG. 13A shows an example of an image obtained by combining the 2D image input to the video signal processor 306 and having horizontal 1920 pixels to the graphics, and is the same as that shown in FIG. 11A. FIGS. 13B and 13C are an L image and an R image which are generated by performing the process based on the characteristics shown in FIGS. 5A to 5C to the combined image, and performing the process based on the characteristics shown in FIGS. 12A to 12C to the graphics. The 200th pixel in the input 2D image is moved to the 191st pixel in the L image and moved to the 209th pixel in the R image. As a result, a 16-pixel parallax is generated between the R image and the L image. On the other hand, the 960th pixel located near the center in the horizontal direction in the input 2D image is moved to the 935th pixel in the L image and moved to the 985th pixel in the R image. As a result, 50-pixel parallax is generated between the R image and the L image. That is, between the generated R and L images, a parallax amount near the center in the horizontal direction is larger than parallax amounts near both the ends in the horizontal direction. Thus, as shown in FIG. 11D, a 3D image visually recognized by a user through the 3D glasses 103 is an image recognized by the user such that both horizontal end portions are substantially near the display surface of the display apparatus 201, and a horizontal central portion is present on the rear of both the horizontal end portions on a curved surface.

On the other hand, in the graphics, the 300th pixel configuring the left end of the input graphics is moved to the 290th pixel in the L image and moved to the 310th pixel in the R image. As a result, a 20-pixel parallax is generated between the R image and the L image. On the other hand, the 1620th pixel configuring the right end of the input graphics is moved to the 1610th pixel in the L image and moved to the 1630th pixel in the R image. As a result, similarly to the L image, a 20-pixel parallax is generated between the R image and the L image. Thus, as shown in FIG. 13D, a 3D image visually recognized by a user through the 3D glasses 103 is an image that appears so that planar graphics are raised with respect to a curved image.

As described above, according to the reproducing apparatus 101 Embodiment 4, similarly to Embodiment 3, not only the 2D image but also the graphics data can be 3-dimensionalized and displayed. Thus, a 3D effect can also be obtained with respect to the graphics data. In particular, in this embodiment, conversion is performed such that an offset between the L image data and the graphics data combined with the R image data different, and conversion is performed such that an offset between the R image data and the graphics data combined with the R image data different. With this manner, independent 3D effects can be obtained in the graphics data and the L and R image data. In particular, in Embodiment 4, the same effects as those in Embodiments 1 and 2 can be obtained for an image, and an effect that raises planar graphics with respect to a curved image can also be obtained. When the graphics are raised, an effect of causing the graphics to be easily recognized can be obtained.

### Other Embodiments

Embodiments 1 to 4 have been illustrated as the embodiments of the present invention. However, the present invention is not limited to these embodiments. Other embodiments of the present invention will be collectively described below. Note that the present invention is not limited thereto, and can also be applied to an embodiment that is appropriately corrected.

In Embodiments 1 to 4, the case in which the present invention is applied to a 2D image has been described. However, the present invention may also be applied to a 3D image. In this case, a 3D effect such as a protruding amount can be adjusted to adjust a parallax amount in the 3D image.

In each of the embodiments, although the image is configured to be recognized by a user so that the horizontal central portion of the generated 3D image protrudes to the forefront or is present on the most rear side, this forefront position or the most rear position may be an arbitrary position on the left or right of the central portion instead of the horizontal central portion. For example, when a 2D image serving as a 3D image source includes a person or the like therein, a position where the person or the like is present may be detected, and the image may be configured to be recognized by a user so that the position protrudes to the forefront.

In the embodiment, although the horizontal magnification is changed based on only the horizontal pixel position, the horizontal magnification may be change in consideration of a vertical pixel position. For example, a change rate of a horizontal magnification of an upper portion of an input image may be set to be large, and the change rate of the horizontal magnification may be reduced toward the lower portion. In this case, the lower portion of the image is recognized by a user so that the lower portion relatively protrudes to the front of the upper portion.

A horizontal magnification may be changed based on a state of an image. For example, in a dark scene in which a field of view of the human being becomes narrow, setting is performed such that a parallax amount decreases. In a bright scene, setting is performed such that a parallax amount increases. For example, a brightness (average value) of an entire image is obtained, and a parallax amount is determined based on the brightness.

An output amplitude of both horizontal ends (both the left and right ends) in a 3D image is reduced. However, output amplitudes of not only both the horizontal ends (both the left and right ends) but also output amplitudes (gains) of both the vertical ends (both the upper and lower ends) may be reduced. With this manner, uncomfortable feeling occurring by cutting an image having a parallax with a television frame without a parallax can be reduced.

A reduction in image amplitude to reduce the uncomfortable feelings at both the screen ends is realized by making an output gain of an image variable. However, a combination ratio (a value) to the graphics (OSD screen) is set to OSD 100% and video 0% at both the horizontal ends, the combination ratio is set to OSD 0% and video 100% in a region in a gain of 1 in FIG. 7C, and the combination ratio may be made continuously variable in the other region to reduce the image amplitude so as to reduce the uncomfortable feeling. In this case, since a brightness level of the OSD screen is variable, for example, the brightness level of the OSD is set to an average brightness level of the screen so that such an appearance is realized in which blurring at both the horizontal ends does not become black but become faint.

A region in which output amplitudes at both the horizontal ends (and both the vertical ends) in the 3D image are reduced may be made variable depending on parallax information of an image input to the video signal processor 306.

A region in which output amplitudes at both the horizontal ends (and both the vertical ends) in the 3D image are reduced may be made variable depending on a parallax amount that is increased or decreased by processing performed to an image input to the video signal processor 306.

In Embodiment 1 and Embodiment 2, similarly to Embodiment 3, a 2D image and graphics input to the video signal processor 306 may be subjected to different processings and then combined with each other. With this manner, for example, the graphics can be displayed while always being raised from the image.

The image processing may be performed in combination with audio processing. For example, conversion may be performed such that acoustic fields are formed at the rear when the center in the horizontal direction is recessed. With this manner, the effect of image conversion can be further enhanced.

In Embodiment 3, after different processings are performed to image data and graphics data, respectively, the image data and the graphics data are combined with each other. However, after processing serving as a difference between the image data and the graphics data may be performed to the graphics data, the graphics data may be combined with the image data, and processing in the horizontal direction may be performed to the combined image.

In Embodiment 1, the display apparatus 102 displays the left-eye image and the right-eye image such that the images are alternately switched, and in synchronization with the switching, the left and right shutters of the 3D glasses 103 are alternately switched. However, the following configuration may also be used. That is, the display apparatus 102 displays the left-eye image and the right-eye image such that odd-number lines and even-number lines are separated from each other with respect to each of the lines, and different polarizing films are respectively stuck to the odd-number lines and the even-number lines in the display unit. The 3D glasses 103 do not use a liquid crystal shutter system. Polarizing filters having different directions are stuck to the left-eye lens and the right-eye lens to separate the left-eye image from the right-eye image with the polarizing filters. The display apparatus may be configured such that a left-eye image and a right-eye image are alternately displayed in a lateral direction per each pixel, and polarizing films having different planes of polarization are alternately stuck to the display unit per each pixel. In short, left-eye and right-eye image data may be configured to be caused to reach the left eye and the right eye of the user, respectively.

The reproducing apparatus 101 is configured to reproduce data on the disk 201 by the disk reproducing unit 202. However, a 2D image serving as a source may be a stream input obtained through a broadcasting station or a network or data recorded on a recording medium such as a blue-ray disk, a DVD disk, a memory card, or a USE memory.

In Embodiments to 4, conversion of video images is exemplified. However, the present invention is not limited thereto. Specifically, the present invention can also be applied to a still image such as a JEPG image.

In each of the embodiments, although conversion of a 2D image into a 3D image is performed in the signal processor 203 of the reproducing apparatus 101, means having the same conversion function may be arranged in the display apparatus 102 to perform the conversion in the display apparatus 102.

### INDUSTRIAL APPLICABILITY

The present invention can be applied to an image conversion apparatus that converts a 2D image into a 3D image. For example, the present invention can be applied to, in particular, 3D image compatible devices such as a 3D blue-ray disk player, a 3D blue-ray disk recorder, a 3D DVD player, a 3D DVD recorder, a 3D broadcast receiving device, a 3D television set, a 3D image display terminal, a 3D mobile phone terminal, a 3D car navigation system, a 3D digital still camera, a 3D digital movie, a 3D network player, a 3D-compatible computer, and a 3D-compatible game player.

### DESCRIPTION OF REFERENCE NUMERALS

101: Reproducing apparatus
102: Display apparatus
103: 3D glasses
201: Disk
202: Disk reproducing unit
203: Signal processor
204: Memory
205: Remote-control receiver
206: Output unit
207: Program storing memory
301: Stream separating unit
302: Audio decoder
303: Video decoder
304: Graphics decoder
305: CPU
306: Video signal processor

1-20. (canceled)

21. An image conversion apparatus that converts non-stereoscopic image data into stereoscopic image data configured by left-eye image data and right-eye image data, the image conversion apparatus comprising:
an input unit operable to receive an input of a non-stereoscopic image; and
a conversion unit operable to generate and output the left-eye image data and the right-eye image data based on the non-stereoscopic image data input through the input unit, wherein
the conversion unit performs conversion to make an offset of the left-eye image data and an offset of graphics data combined with the left-eye image data different from each other, and to make an offset of the right-eye image data and an offset of graphics data combined with the right-eye image data different from each other.

22. The image conversion apparatus according to claim 21, wherein
when a stereoscopic image configured by a left-eye image and a right-eye image is displayed on a display apparatus capable of displaying a stereoscopic image, the conversion unit generates the left-eye image data and the right-eye image data to cause a user to visually recognize the stereoscopic image so that a predetermined portion in a horizontal direction in the displayed stereoscopic image is present at a position farthest from the user in a direction vertical to a display surface of the display apparatus, and a portion other than the predetermined portion is present at a position closer to the user toward left and right ends of the stereoscopic image.

23. The image conversion apparatus according to claim 21, wherein
the conversion unit generates the left-eye image data and the right-eye image data to cause a user to recognize a stereoscopic image configured by the left-eye image and the right-eye image when the stereoscopic image is displayed on the display apparatus capable of displaying a stereoscopic image, so that the entire displayed stereoscopic image is present at a position farther from the display surface of the display apparatus when viewed from the user in a direction vertical to the display surface of the display apparatus.

24. The image conversion apparatus according to claim 22, wherein the predetermined portion is substantially a central portion in a horizontal direction.

25. The image conversion apparatus according to claim 21, wherein the conversion unit receives two pieces of identical non-stereoscopic image data, and provides different moving distances for a left-eye image and a right-eye image to pixels configuring the non-stereoscopic image data to generate the left-eye image data and the right-eye image data.

26. The image conversion apparatus according to claim 21, wherein the conversion unit reduces image amplitudes at ends of a left-eye image and a right-eye image.

27. The image conversion apparatus according to claim 21, wherein the conversion unit changes a region in which image amplitudes at ends of a left-eye image and a right-eye image are reduced depending on a parallax amount.

28. The image conversion apparatus according to claim 22, further comprising a receiving unit that receives an instruction to adjust a display position of the stereoscopic image in a direction vertical to the display surface of the display apparatus.

29. An image conversion apparatus that converts non-stereoscopic image data into stereoscopic image data configured by left-eye image data and right-eye image data, the image conversion apparatus comprising:
an input unit operable to receive an input of a non-stereoscopic image; and
a conversion unit operable to generate and output the left-eye image data and the right-eye image data based on the non-stereoscopic image data input to the input unit, wherein
when a stereoscopic image configured by a left-eye image and a right-eye image is displayed on a display apparatus capable of displaying a stereoscopic image, the conversion unit generates the left-eye image data and the right-eye image data to cause a user to visually recognize the stereoscopic image so that an entire displayed stereoscopic image is present at a position farther than the display apparatus when viewed from the user in a direction vertical to a display surface of the display apparatus, a predetermined portion in the horizontal direction in a display region of the display apparatus is present at a closest position, and a portion other than the predetermined portion is present at a position farther from the user toward left and right ends of a stereoscopic image.

30. The image conversion apparatus according to claim 29, wherein
the conversion unit generates the left-eye image data and the right-eye image data to cause a user to recognize a stereoscopic image configured by the left-eye image and the right-eye image when the stereoscopic image is displayed on the display apparatus capable of displaying a stereoscopic image, so that end portions on the left and right of the predetermined portion are present at predetermined positions in a direction vertical to the display surface of the display apparatus.

31. The image conversion apparatus according to claim 29, wherein the predetermined portion is substantially a central portion in a horizontal direction.

32. The image conversion apparatus according to claim 29, wherein the conversion unit receives two pieces of identical non-stereoscopic image data and provides different moving distances for the left-eye image and the right-eye image to pixels configuring the non-stereoscopic image data to generate the left-eye image data and the right-eye image data.

33. The image conversion apparatus according to claim 29, wherein the conversion unit reduces image amplitudes at ends of the left-eye image and the right-eye image.

34. The image conversion apparatus according to claim 29, wherein the conversion unit changes a region in which image amplitudes at ends of the left-eye image and the right-eye image are reduced depending on a parallax amount.

35. The image conversion apparatus according to claim 29, further comprising a receiving unit that receives an instruction to adjust a display position of the stereoscopic image in a direction vertical to the display surface of the display apparatus.

36. An image conversion apparatus according to claim 29, wherein the conversion unit performs conversion to make an offset of the left-eye image data and an offset of graphics data combined with the left-eye image data different from each other, and an offset of the right-eye image data and an offset of graphics data combined with the right-eye image data different from each other.

37. An image conversion apparatus that processes stereoscopic image data, the image conversion apparatus comprising:
an input unit operable to receive an input of a stereoscopic image; and
a conversion unit operable to provide different moving distances to a left-eye image and a right-eye image of the stereoscopic image based on the stereoscopic image data input through the input unit to generate and output left-eye image data and right-eye image data, wherein
the conversion unit converts the inputted stereoscopic image to make a moving distance provided to the left-eye image data different from a moving distance provided to graphics data combined with the left-eye image data, and a moving distance provided to the right-eye image data different from a moving distance provided to graphics data combined with the right-eye image data.

38. The image conversion apparatus according to claim 37, wherein when differences between moving distances provided to left-eye image data and right-eye image data generated from the identical stereoscopic image data are compared with each other, the conversion unit generates the left-eye image data and the right-eye image data to make a difference between moving distances provided to a first pixel position of the stereoscopic image different from a difference between moving distances provided to a second pixel position different from the first pixel position.

39. The image conversion apparatus according to claim 37, further comprising a receiving unit that receives an instruction to adjust a moving distance.

40. The image conversion apparatus according to claim 37, wherein image amplitudes at ends of the left-eye image data and the right-eye image data are reduced.
